(19) United States
(12) Patent Application Publication
(10) Pub. No.: US 2007/0209155 A1
(43) Pub. Date: Sep. 13, 2007

(54) Interlocking Hinge Mount

(75) Inventors: Scott Joseph Duggan, Indianapolis, IN (US); Darin Bradley Ritter, Indianapolis, IN (US); Jon William Kangas, Greenwood, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING INC., PRINCETON, NJ (US)

(21) Appl. No.: 10/593,547

(22) PCT Filed: Mar. 21, 2005
(86) PCT No.: PCT/US05/09241

§ 371 Date: Sep. 19, 2006

Related U.S. Application Data
(60) Provisional application No. 60/556,922, filed on Mar. 26, 2004.

(51) Int. Cl. E05D 11/00

(52) U.S. Cl. 16/223

(57) ABSTRACT

A hinge for mounting a projection display screen (10) to a cabinet (20) from the front of the screen is disclosed. A cabinet hinge part (40) is attached to the cabinet (20), and a screen hinge part (50) is attached to a screen frame (12) having the screen (10) mounted on it. Both the cabinet hinge part (40) and the screen hinge part (50) are elongate, stiff members, with one of the cabinet hinge part (40) and the screen hinge part (50) having an arcuate slot (42) extending along its elongate dimension and the other of the cabinet hinge part (40) and the screen hinge part (50) having an arcuate projection extending along its elongate dimension, where the arcuate projection (52) is pivotally interlockable with the arcuate slot (42).

### CROSS-REFERENCE TO RELATED APPLICATIONS

This application claims the benefit of U. S. Provisional Patent Application Ser. No. 60/556,922, entitled “Interlocking Hinge Mount for top of Screen Frame of a Projection Display” and filed Mar. 26, 2004, which is incorporated by reference herein in its entirety.

### FIELD OF THE INVENTION

The invention relates generally to a projection display and, in particular a frame for a projection display screen.

### BACKGROUND OF THE INVENTION

Projection display televisions have become widely used. The cabinets for these projection display televisions are typically made from plastic. A problem that projection display televisions typically have is keeping the top edge of the screen straight and in the proper location. Plastic cabinets provide nice aesthetics but have a tendency to bow along the top edge, aggravating the ability to keep the top edge of the screen straight and in location. This is an even more severe problem on projection display televisions that incorporate upangle optics because such televisions require a more accurate screen location with respect to the optics.

Existing methods that are used to hold the top edge of the screen include screws from behind the set that drive into bosses in the screen frame. However, access to the screws is a problem if the set is hanging on the wall. Another prior art technique uses metal brackets or wooden blocks along the top edge of the cabinet that allow the screen frame to hook on and swing down into position. However, these mounting systems rely on the straightness and stiffness of the basic cabinet to keep the top edge of the screen straight and in location. These blocks or brackets are intermittent and do not hold the screen along its entire length which may lead to slight undulations in the top edge of the screen frame.

### SUMMARY

The present invention provides a hinge for mounting a projection display screen to a cabinet from the front of the screen. A cabinet hinge is attached to the cabinet, and a screen hinge is attached to a screen frame having the screen mounted on it. Both the cabinet hinge and the screen hinge are elongate, stiff members, with one of the cabinet hinge and the screen hinge having an arcuate slot extending along its elongate dimension and the other of the cabinet hinge and the screen hinge having an arcuate projection extending along its elongate dimension, where the arcuate projection is pivotally interlockable with the arcuate slot.

### BRIEF DESCRIPTION OF THE DRAWINGS

Exemplary embodiments of the present invention will next be described with reference to the accompanying figures, of which:

FIG. 1A is a prospective front view of a projection display television according to an exemplary embodiment of the present invention;

FIG. 1B is a prospective rear view of the projection display television of FIG. 1A;

FIG. 2A is a partial rear perspective view of the projection display television of FIGS. 1A and 1B, showing a hinge assembly according to an exemplary embodiment of the present invention;

FIG. 2B is an exploded view of the hinge of assembly of FIG. 2A, showing a frame hinge and a screen hinge;

FIG. 3A is a sectional view of the frame hinge of FIG. 2B;

FIG. 3B is a sectional view of the screen hinge of FIG. 2B; and

FIG. 3C is a sectional view of the hinge assembly of FIG. 2A.

### DETAILED DESCRIPTION

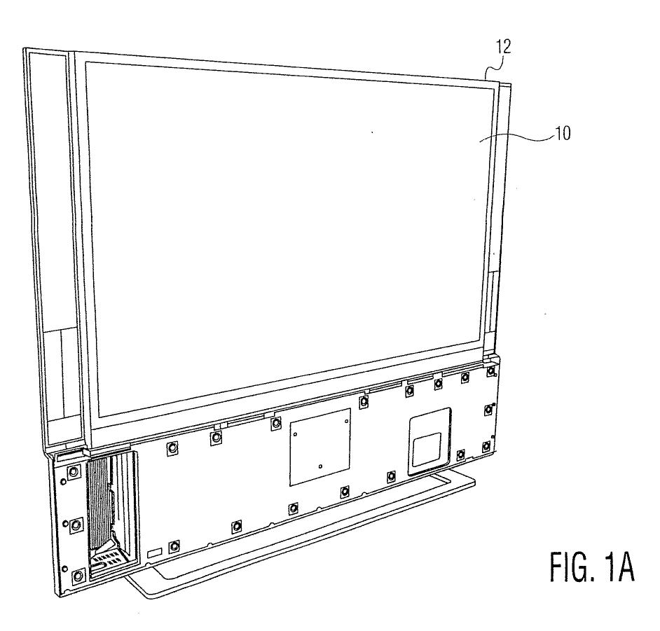

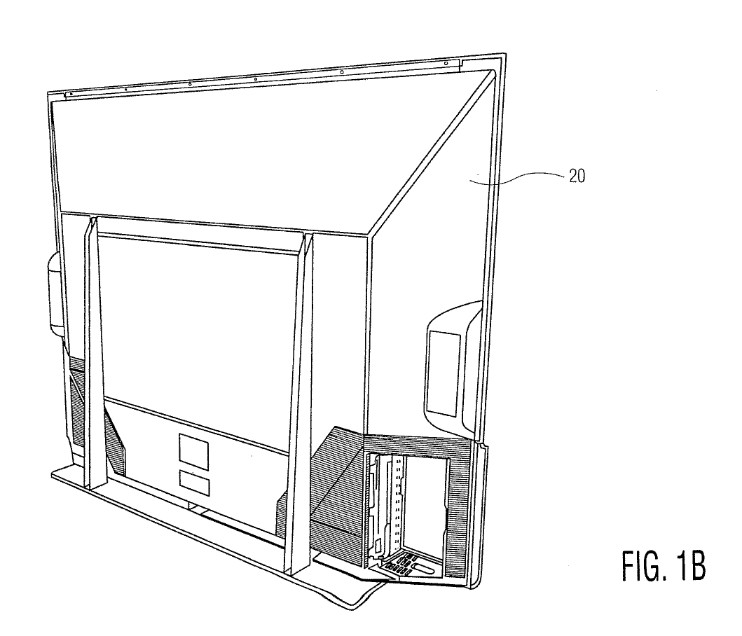

The present invention, shown in FIGS. 1A-3C, provides an extruded metal hinge mechanism that keeps the top of the projection display television screen frame straight and allows the screen assembly to be removed from the front without the use of screws from the rear.

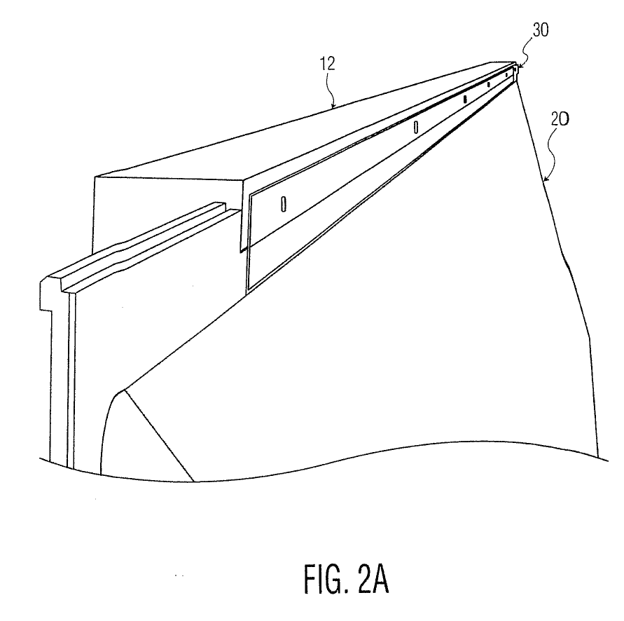

An exemplary projection display television is shown in FIGS. 1A and 1B. A screen 10 is mounted in a screen frame 12, and the screen 10 and screen frame 12 are mounted to a cabinet 20. As best shown in FIG. 2A, the screen frame 12 is mounted to the cabinet 20 by a hinge assembly 30. The hinge assembly 30 comprises a cabinet hinge 40 and a screen hinge 50, as shown in FIG. 2B. In an exemplary embodiment of the invention, the cabinet hinge 40 and the screen hinge 50 are aluminum extrusions, that work in concert as a continuous stiffener for the screen frame 12 and cabinet 20. Aluminum extrusions are inexpensive to fabricate and provide good dimensional stability and stiffness properties.

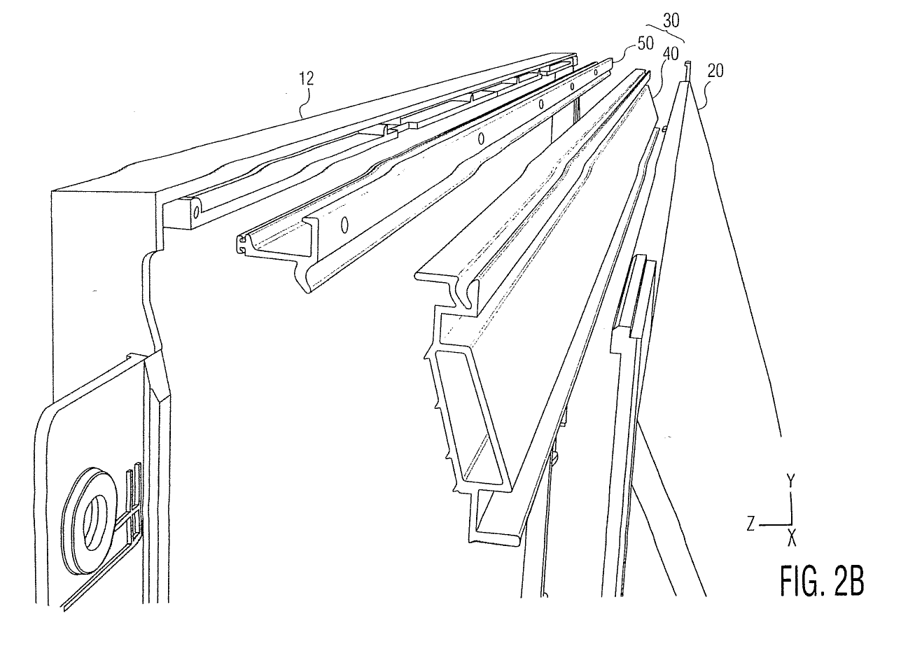

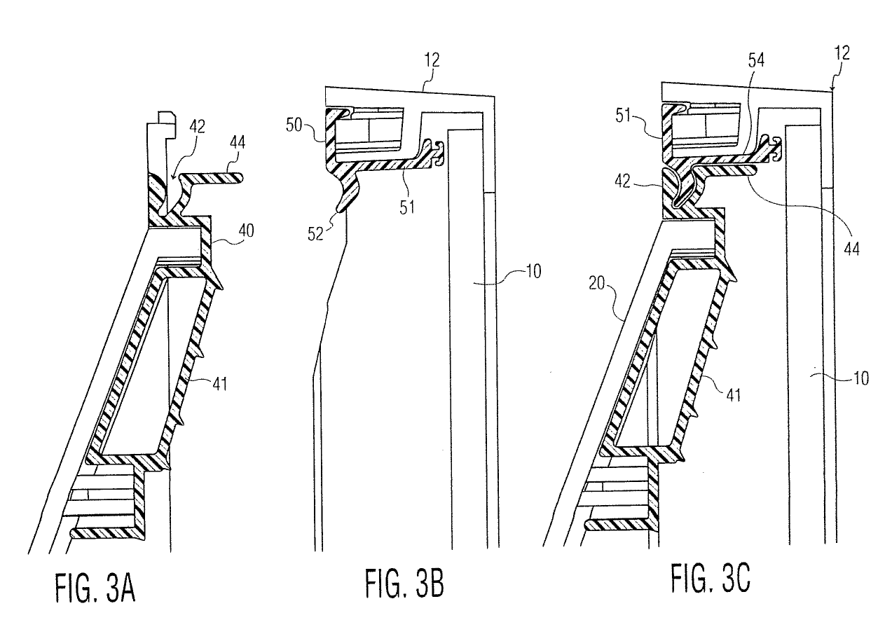

As shown in FIGS. 3A-3C, the cabinet hinge 40 and the screen hinge 50 also incorporate hinge details that allows the screen frame to be easily removed from the front of the set without the need for removing screws from behind the television. The cabinet hinge 40 comprises: an anchoring portion 41 that attaches to the cabinet 20, a stop 44 that abuts a corresponding stop 54 (shown in FIG. 3 C) when the screen 10 is pivoted into an operating position with respect to the cabinet 20, and a hinge portion 42. In an exemplary embodiment, the anchoring portion 41 conforms to projections and/or recesses in the cabinet 20 to form a press fit with the cabinet 20. The hinge portion 42 is an arcuate slot in the illustrated embodiment. The cabinet hinge 40 and the hinge portion 42 extend essentially the length of the elongate direction (i.e., entire width of the cabinet 20), stiffening the entire top edge of the cabinet 20.

The screen hinge 50 comprises: an anchoring portion 51 that attaches to the screen frame 12, a stop 54 that abuts the corresponding stop 44 when the screen 10 is pivoted into an operating position with respect to the cabinet 20, and a hinge portion 52. In an exemplary embodiment, the anchoring portion 51 conforms to projections and/or recesses in the screen frame 12 to form a press fit with the screen frame 12. The hinge portion 52 is an arcuate projection in the illustrated embodiment. The screen hinge 50 and the hinge portion 52 extend essentially the length of the elongate direction (i.e., entire width of the screen frame 12), stiffening the entire top edge of the screen frame 12, holding the top edge of the screen 10 straight and in the proper location.

In an exemplary embodiment, the cabinet hinge 40 and screen hinge 50 are continuous integral members. By being continuous, the cabinet and screen hinges 40, 50 keep the top edge of the screen 10 and screen frame 12 straight. Optionally, the cabinet and screen hinges 40, 50 may have a constant cross section along the elongate dimension, making them relatively easy and inexpensive to extrude.

The cabinet may be plastic, as is typical for projection display televisions. When mounted to a plastic cabinet, these hinges 40, 50, in the form of extrusions, form a low profile, structural member along the top edge of the cabinet 20. This structural member can be tied into other structural members of the cabinet 20 to help maintain the critical location of the screen frame 12. Along with being very low cost to tool, aluminum extrusions tend to be inherently straight, stiff and stable as compared to other parts such as plastic extrusions, formed sheet metal, wood, or molded plastic.

The screen 10 and screen frame 12 are held from the front of the screen, and the screen hinge 50 attached to the screen frame is interlocked with the cabinet hinge 40 by inserting the arcuate protrusion (in the illustrated embodiment, the hinge portion 52) into the arcuate slot (in the illustrated embodiment, the hinge portion 42) and pivoting the screen 10 and screen frame into place.

Additionally, since the extrusions are linear, it is relatively inexpensive to incorporate “light stop” details that reduce harmful effects of stray light in the cabinet 20. For example, the anchoring members 41, 51 can extend over a portion of cabinet 20 and screen frame 12, respectively, preventing light from entering at the junctions of the cabinet and screen frame with the hinges. Moreover, the continuous arcuate protrusion 52 resting in the continuous arcuate slot 42 prevents light from entering the cabinet 20 through the hinges 40, 50.

The abutting stops 44, 54 provide both: mechanical support for the screen 10 and screen frame 12 by the cabinet 20, and vertical positioning of the screen 10.

The foregoing illustrates some of the possibilities for practicing the invention. Many other embodiments are possible within the scope and spirit of the invention. For example, while the exemplary embodiment provides an arcuate protrusion on the screen hinge and an arcuate slot in the cabinet hinge, the arcuate protrusion and arcuate slot could be reversed, such that the arcuate protrusion is on the cabinet hinge and the arcuate slot is in the screen hinge. This basic hinge concept is also applicable with roll formed sheet metal or sheet metal parts made on progressive dies. It is intended, therefore, that the foregoing description be regarded as illustrative rather than limiting; and that the scope of the invention be given by the appended claims together with their full range of equivalents.

I/we claim:

1. A hinge for mounting a projection display screen to a cabinet from the front of the screen, comprising:
a cabinet hinge attached to the cabinet; and
a screen hinge attached to a screen frame having the screen mounted thereto;
wherein both the cabinet hinge and the screen hinge are elongate, stiff members, one of the cabinet hinge and the screen hinge having an arcuate slot extending along its elongate dimension and the other of the cabinet hinge and the screen hinge having an arcuate projection extending along its elongate dimension that is pivotally interlockable with the arcuate slot.

2. The hinge of claim 1 wherein the cabinet hinge and the screen hinge are continuous.

3. The hinge of claim 2 wherein the cabinet hinge and the screen hinge have a constant cross section along the elongate dimension.

4. The hinge of claim 1 wherein the cabinet hinge and the screen hinge are extrusions.

5. The hinge of claim 1 wherein the cabinet hinge and the screen hinge are formed of aluminum.

6. The hinge of claim 1 wherein the cabinet hinge and the screen hinge have stops extending essentially parallel to the elongate direction and abutting one another when the screen is hingedly mounted to the cabinet.

7. A projection display, comprising:
a cabinet;
a screen mounted in a screen frame; and
a binge assembly having a cabinet hinge attached to the cabinet and a screen hinge attached to the screen frame, both the cabinet hinge and the screen hinge being elongate, stiff members, one of the cabinet hinge and the screen hinge having an arcuate slot extending along its elongate dimension and the other of the cabinet hinge and the screen hinge having an arcuate projection pivotally disposed in the arcuate slot.

8. The projection display of claim 7 wherein the cabinet hinge and the screen hinge are continuous.

9. The projection display of claim 8 wherein the cabinet hinge and the screen hinge have a constant cross section along the elongate dimension.

10. The projection display of claim 7 wherein the cabinet hinge and the screen hinge are extrusions.

11. The projection display of claim 7 wherein the cabinet hinge and the screen hinge are formed of aluminum.

12. The projection display of claim 7 wherein the cabinet hinge and the screen hinge have stops extending essentially parallel to the elongate direction and abutting one another when the screen is hingedly mounted to the cabinet.
